(19) United States
(12) Patent Application Publication
(10) Pub. No.: US 2020/0368999 A1
(43) Pub. Date: Nov. 26, 2020

(54) MAT FOR PROTECTION FROM HIGH TEMPERATURE ITEMS

(71) Applicant: POWER BOX AG, Zug (CH)

(72) Inventors: Daniel Pikarski, Yoevil (GB); Simon Bird, Yoevil (GB)

(21) Appl. No.: 16/636,227

(22) PCT Filed: Aug. 22, 2018
(86) PCT No.: PCT/IB2018/056340

§ 371 Date: Feb. 3, 2020

(30) Foreign Application Priority Data
Aug. 22, 2017 (GB) 1713456.0

(51) Int. Cl. B32B 5/26; B32B 17/02; B32B 5/02

(52) U.S. Cl. CPC B32B 5/26; B32B 17/02; B32B 5/022; B32B 5/024; B32B 2571/00; B32B 2262/108; B32B 2307/304; B32B 2307/3065; B32B 2262/101

(57) ABSTRACT

The invention relates to a mat for location and use as a thermal harrier between a heat source such as a burner flame or a heated item created, for example, when performing work on plumbing pipework adjacent to the mat, and a surface such as a floor or wall or another item which is to be protected from the heat. The mat is formed from first and second outer layers which are joined together around their periphery to form, a cavity in which at least one intermediate insulating layer of a material, in one embodiment aerated glass fibres, is provided. The combination of the outer layers and intermediate layer allows the prevention of the passage of heat at temperatures achieved during normal working procedures, through the mat.

The invention to which this application relates is to a mat which is provided to allow protection of an article, work surface, flooring, wall and/or a person, from high temperature items and or heat sources which may be deliberately or inadvertently placed onto the said mat.

In certain activities such as for example welding, jewellery making, plumbing and the like, there is a need to use relatively high temperatures, typically generated via a burner, blow torch or welding apparatus, in order to allow a particular activity to be performed such as, for example, the application of solder material to join pipes or metal items together, the use of burners or welding equipment to melt a portion of an item to allow work to be performed on the same. As a consequence of this, there is a need to be able to protect the surrounding environment and or persons who are performing this work. It is found that this problem has become greater as the use of higher temperature equipment has become more prevalent and so the temperatures from which protection is required, have increased.

Whilst it is known to be able to protect items through the use of a sheet of material, it is found that the sheet material only provides protection for a limited period of time until the same is burnt through and therefore over time the heat source reaches the surface which is being protected, to burn the same. In some forms, the bulk of the sheet material is such that it is expensive to purchase and or may be difficult to use in certain areas such as, for example, in a confined area it may be difficult to lay out the sheet material in a manner so as to provide the required protection. Another problem is that conventionally the sheet material will be formed of, or include, asbestos which, while it is effective, causes problems in the safe disposal of the product when its life has expired and/or if an outer protective layer is cut or punctured then exposure to the asbestos can be hazardous to the user and/or others in the environment in which the mat is being used.

The aim of the present invention is therefore to provide a protective mat or sheet material of a form which is particularly effective in providing the protection for a surface which lies to a first side of the mat, from a high temperature item or heat source which is placed on or adjacent to, or is applied to, the opposing surface of the mat and to provide this in a manner which allows the mat to be effective and relatively easy to use repeatedly.

In a first aspect of the invention, there is provided a thermal protective mat, said mat formed with first and second, opposing, outer layers and at least one intermediate layer, wherein said first outer layer having an external surface provided to form the face of the mat exposed to the heat source in use and said second outer layer having an external surface provided to form the face of the mat in contact with or positioned adjacent to a surface or article which is to be protected from the heat and said at least one intermediate layer is formed from a fibrous material to act as an insulation layer.

In one embodiment, the fibrous material is pre-conditioned prior to placement between the first and second outer layers.

In one embodiment the fibrous material includes any, or any combination, of felt, rock, glass and/or mineral fibres.

In one embodiment the fibres of the intermediate layer are held and retained as a relatively soft mass of material.

In one embodiment the said intermediate layer includes a series of sub-layers which are retained together by the fibres. to form the intermediate layer.

In one embodiment t e external faces of the intermediate layer lie substantially parallel to the said outer layers of the mat.

In one embodiment the intermediate layer is substantially formed of glass fibres which are conditioned by applying air to form an aerated glass fibre intermediate layer.

In one embodiment the preconditioning steps for the intermediate layer include any or any combination of stretching and/or aerate and/or blowing and/or pulling apart the fibres which form the layer so as to form a relatively loosely joined intermediate layer. It is found that the preconditioning of the intermediate layer allows the effectiveness of the intermediate layer in mitigating and reducing the effect of the high temperature which is applied onto the external surface of the mat, to be improved.

In one embodiment the preconditioning step is provided to increase the bulk of the intermediate layer such that the same has a depth in the range of 0.75 cm-2.0 cm. In one embodiment the said intermediate layer is retained in a cavity formed between the outer layers in a compressed form.

In one embodiment the intermediate layer acts as an insulating layer.

In one embodiment, the said first and second outer layers are joined together at least around their periphery to form, between the same, a cavity, in which the said intermediate layer is located.

In one embodiment, the said first and second outer layers, include the same material, which in one embodiment are glass fibres. In one embodiment the said outer layers are woven.

In one embodiment the structures of the respective outer layers are different. In one embodiment one of the outer layers has an external face which is coated and sealed. In one embodiment said sealed face is that which is to be positioned in contact with or adjacent the surface or item which is to be protected from the heat.

In one embodiment one or both external layers are provided to have an intumescent effect.

In one embodiment one or both of the first and/or second outer layers are provided with an external surface which is relatively hard wearing so as to prevent puncture from any items which are placed onto the same and/or may be provided with one or more coatings to render the same waterproof so as to prevent any liquids which fall onto the twat from entering the intermediate layer and potentially affecting or altering the structure of the intermediate layer.

Typically, the mat can be provided of a suitable shape and dimensions so as to be appropriate for a particular use and/or use in a particular environment and, in one embodiment, a range of said mats are provided of differing dimensions so as to allow the same to be used for a range of purposes. Typically, the reduction in the temperature which is achieved between the different sides of the mat is such as to allow the effect of the high temperature applied to one side of the mat being reduced to such an extent that the application of the high temperature has no impact on the surface or item which is protected by the mat.

In one embodiment, the thickness of the intermediate layer can be selected to suit a particular anticipated use of the mat so as to thereby allow the performance of the mat to be determined for particular uses. For example, a thicker intermediate layer may be provided for mats which are designed to be used to provide protection from items which may have a higher temperature range than a mat which isn't designed to be used for items with a lower predicted temperature range.

In one embodiment at least one of the said outer layers is formed so as to be substantially liquid resistant to prevent the ingress of liquid into the intermediate layer from that outer layer.

In one embodiment the mat is capable of withstanding and protecting a surface from a flame which is directly impacting on the first outer layer.

In one embodiment the mat is capable of withstanding heat, at a temperature of up to 750 degrees Celsius.

Specific embodiment of the invention is now described with reference to the accompanying drawings; wherein.

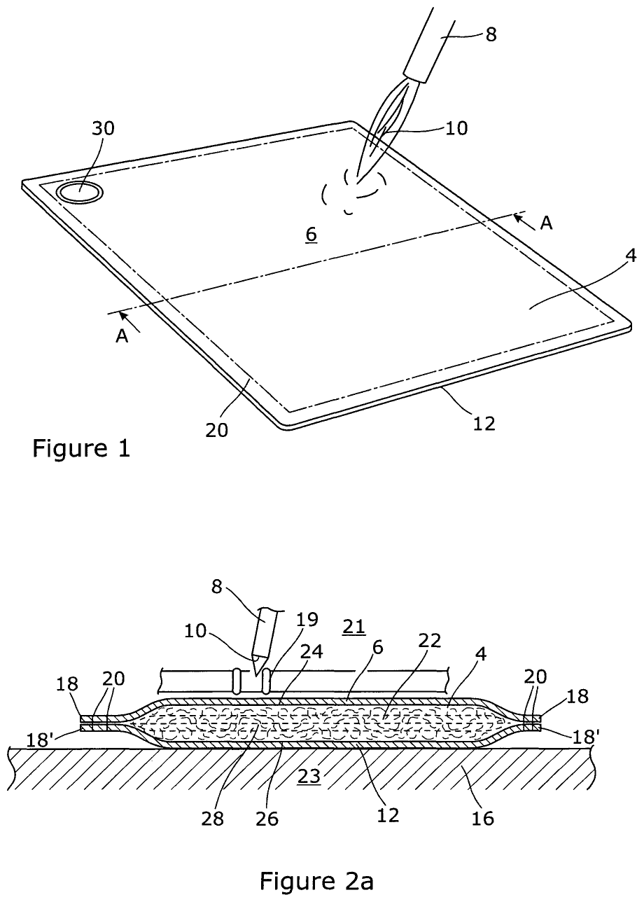

FIG. 1 illustrates a perspective view of a mat in accordance with one embodiment of the invention; and

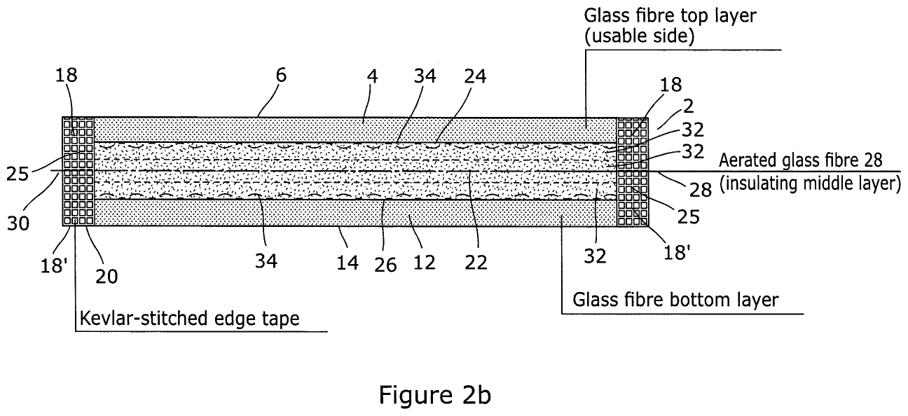

FIGS. 2a and b illustrate cross-sectional end elevations of the mat of FIG. 1 along line AA with FIG. 2a showing the mat in use and FIG. 2b showing the layers of the mat in a schematic form.

The mat in accordance with this embodiment of the invention is typically provided for use in any suitable industry or domestic use where there is a requirement to provide a barrier against the impact of heat being applied. The invention in the form of the mat is particularly suited for use in industries or services where the application of the heat is required to be performed in situ and which therefore require temporary protection to be put in place surrounding the apparatus which is being installed or serviced while the work is being performed using high temperatures. The form of work can vary but may, for example be, such as, the work performed by plumbing/heating and/or maintenance trades, such as using solder and heat to join pipes together in a domestic environment where there is a risk that potentially valuable items can be damaged and/or surfaces can be burnt and/or the appearance damaged. The mat in accordance with the invention is provided to prevent burn damage when the high temperature works such as soldering or brazing is being performed and during which the apparatus being used and/or components and/or debris is at a high temperature. The mat can be used to protect decorative surfaces such as the items of surfaces of furniture, timber, wiring and also to mask potentially flammable items such as floor covering and the like.

Referring now to the FIGS. 1-2b, there is illustrated a mat 2 formed in accordance with one embodiment of the invention. The mat can be formed of a predetermined size to cover a specified area and it is envisaged that different sizes of the mat will be manufactured and available to purchase by users to suit their particular requirements.

The mat in accordance with this embodiment includes a first outer layer 4 which has an external surface 6 which forms the face of the mat directed towards the heat source when in use. The material which is used to form this outer layer is sufficiently resistant to naked flames such that it will resist the impact of exposure to, for example a blow torch 8 flame which may be directly or indirectly applied to the outer layer 4 while the same is being used to perform a heating operation on, for example a pipe joint, in the vicinity of the said outer layer 4 mat.

There is provided a second outer layer 12 which has an external surface 14 which forms the face of the mat which is placed on or adjacent to the surface or item 16, such as a floor or wall, or surface of an item of furniture or an appliance, which is to be protected from the heat. Typically at least this layer is formed or treated to be resistant to the passage of liquid there through.

FIG. 2a shows one possible arrangement of the mat 2 with respect to a pipe joint 19 to which the heat source 8 is applied on one side 21 of the mat and the item in the form of a surface of a floor 16 is provided on the opposing side 23 of the mat and is protected from the heat which does not pass through the mat to any extent which is sufficient to be damaging.

As illustrated in the Figures the peripheries 18, 18′ of the first and second outer layers are joined together, typically by Kevlar stitching 20 of an edge tape 25 so as to define a substantially sealed cavity 22 between the internal surfaces 24, 26 of the first and second outer layers 4,12 respectively. The first and second outer layers 4, 12 are in the embodiment shown in FIG. 2b formed of glass fibres, which are typically woven and both or one of the layers may have a sealant applied thereto, such as to render the same water resistant.

Within the cavity 22 there is retained an intermediate layer 28 of fibrous material which includes glass fibres. In accordance with the invention the fibrous material is preconditioned prior to being sealed in the cavity to form the intermediate layer and the preconditioning includes the aeration of the same and may also include the pulling apart of the fibres whilst ensuring that the same are still retained in sufficient contact so as to act, in conjunction, to form die intermediate layer. In one embodiment the intermediate layer is formed of a series of sub layers 32, all of which, in conjunction with the outer layers run parallel to the same axis 30. The sublayers 32 are joined together by fibres of the respective sub-layers such that they act as one aerated intermediate layer.

Indents and protrusions may be provided on surfaces 34 may be created during preconditioning of the material to form the intermediate layer so as to increase the effective surface area of the intermediate layer and/or increase the effective depth of the intermediate layer 28. In one embodiment at least one of the surfaces 34 of the intermediate layer is provided with indents and protrusions and when provided the same can be provided as a repeating pattern.

It is found that the act of preconditioning the fibres of the intermediate layer significantly improves the ability of the mat as a whole to withstand greater heat temperatures.

As shown in FIG. 1 one or more location means, such as aperture 30, may be formed so as to assist with storage of the mat on, for example a hook, and/or to allow the location of the mat when in position for use such as by the insertion of nails, screws or pins through the apertures. Other location means such as hook and loop fastening means may also be used.

1. A thermal protective mat, said mat formed with first and second, opposing, outer layers and at least one intermediate layer, wherein said first outer layer having an external surface provided to form a face of the mat exposed to a heat source in use and said second outer layer having an external surface provided to form a face of the mat in contact with or positioned adjacent to a surface or article which is to be protected from the heat source and said at least one intermediate layer is formed from a fibrous material to act as an insulation layer.

2. A mat according to claim 1 wherein the fibrous material is preconditioned prior to placement between the first and second outer layers.

3. A mat according to claim 1 wherein the fibrous material includes any or any combination of felt, rock, glass, and/or mineral fibres.

4. A mat according to claim 3 wherein the intermediate layer is formed of glass fibres.

5. A mat according to claim 2 wherein the preconditioning is to stretch and/or aerate and/or blow and/or pull apart the fibres to provide the material in a form ready to be used as the intermediate layer.

6. A mat according to claim 5 wherein preconditioning step increases the bulk of the intermediate layer.

7. A mat according to claim 1 wherein the intermediate layer is formed of a series of sub-layers which are joined together by fibres from the respective adjacent layers intertwined.

8. A mat according to claim 1 wherein at least one surface of the intermediate layer is provided with indents and protrusions.

9. A mat according to claim 8 wherein the indents and protrusions are provided in a repeating pattern.

10. A mat according to claim 1 wherein the said first and second outer layers are joined together at least around their periphery to form between the same, a cavity, in which the said intermediate layer is located.

11. A mat according to claim 1 wherein the said first and second outer layers are formed of glass fibres.

12. A mat according to claim 5 wherein the glass fibres are woven to form the said outer layers.

13. A mat according to claim 1 wherein at least one said outer layers is treated or sealed so as to be rendered water resistant.

14. A mat according to claim 1 wherein the mat is provided to prevent the transfer of high temperatures from one external layer of the mat towards the opposing external layer of the mat.

15. A mat according to claim 14 wherein the mat is capable of preventing the transfer of heat at a temperature of up to 750° C. from one of the outer layers to the said other outer layer.

16. A method of forming a thermal protective mat, said method comprising the steps of: forming the mat with first and second, opposing, outer layers and at least one intermediate layer, with said first outer layer having an external surface provided to form a face of the mat to be exposed to a heat source in use and said second outer layer having an external surface provided to form a face of the mat in contact with or positioned adjacent to a surface or article which is to be protected from the said heat source and wherein said at least one intermediate layer is formed from a fibrous material to act as an insulation layer and a preconditioning step to stretch and/or aerate and/or blow and/or pull apart the fibres of the fibrous material is performed to provide the fibrous material in a form suitable for use as the intermediate layer.
